(19) United States
(12) Patent Application Publication
(10) Pub. No.: US 2024/0060348 A1
(43) Pub. Date: Feb. 22, 2024

(54) ANTI-PINCH SENSOR FOR EXTERIOR BODY CLOSURE

(71) Applicant: Magna Exteriors Inc., Aurora (CA)

(72) Inventors: Keijo J. Huotari, Fenton, MI (US); Scott L. Woods, Bruce Township, MI (US); Christopher J. Kuntze, Goodrich, MI (US)

(73) Assignee: Magna Exteriors Inc., Aurora (CA)

(21) Appl. No.: 18/501,596

(22) Filed: Nov. 3, 2023

Related U.S. Application Data
(63) Continuation-in-part of application No. 17/919,440, filed on Oct. 17, 2022.
(60) Provisional application No. 63/011,632, filed on Apr. 17, 2020.

(51) Int. Cl. E05F 15/48

(52) U.S. Cl. CPC E05F 15/48; E05Y 2900/50

(57) ABSTRACT

A closure panel for a vehicle having an anti-pinch sensor attached at an outer peripheral area of the closure panel. A closure panel including an outwardly extending flange portion. An anti-pinch sensor mount including a U-shaped cross section which is adapted to fit over and secure to the outwardly extending flange portion. An anti-pinch sensor attached to the mount for sensing an interference in opening or closing of the closure panel and reversing the opening or closing of the closure panel.

### CROSS-REFERENCE TO RELATED APPLICATIONS

This application is a Continuation-in-Part of U.S. patent application Ser. No. 17/919,440, filed Oct. 17, 2022, which is the National Stage of PCT International Patent Application No. PCT/US2021/027719, filed Apr. 16, 2021 and claims the benefit of U.S. Provisional Patent Application No. 63/011,632, filed Apr. 17, 2020. The disclosures of the above applications are incorporated herein by reference.

### FIELD OF THE INVENTION

The present invention relates to an anti-pinch sensor for a door of a vehicle. In particular, the present invention is directed to an easy install pinch sensor for a horizontal or vertical exterior body closure.

### BACKGROUND OF THE INVENTION

Anti-pinch sensors are often used by automotive OEM's on the sides of a liftgate as a due care type safety item. Such sensors are used on liftgate doors that have a power actuation system, to stop or reverse a door if there is an obstacle in the way. These anti-pinch sensors create additional parts, additional costs, create assembly complexity, packaging concerns, appearance concerns, and quality concerns. Integrating the mounting surface of the anti-pinch sensor to the liftgate inner panel is an improvement over a conventional molded carrier but continuing to use two-sided sticky tape with adhesion promotor and mechanical fasteners as a primary attachment is not the most efficient.

Thus, it is an object of the present invention to reduce complexity, reduce cost, reduce possibility of poor assembly, improve quality, reduce assembly time, reduce weight, improve appearance when providing for an anti-pinch sensor in a vehicle liftgate and any other closure panel.

### SUMMARY OF THE INVENTION

A liftgate or other closure panel assembly for a vehicle having an anti-pinch sensor attached at an outer peripheral area of the liftgate is provided. The liftgate includes an outwardly extending flange portion. An anti-pinch sensor mount including a U-shaped cross section which is adapted to fit over and secure to the outwardly extending flange portion. An anti-pinch sensor is attached to the mount for sensing an interference in opening or closing of the liftgate and reversing the opening or closing of the liftgate.

This invention allows for a small easy to mold flange on the inner panel, does not require adhesion promotor, or two-sided sticky tape, has better self-locating features, has better performance and durability for real life testing such as car wash brushes.

Creating a pocket in the extrusion portion of the anti-pinch sensor that allows for easy assembly and locating onto a simple flange.

The present invention provides an open section that allows loading on a flange and is integrated into the anti-pinch sensor extrusion without adding extra components.

The invention provides the anti-pinch sensor operable to attach to the outer peripheral area of the closure panel. This invention allows for the easy to form flange on a panel, the anti-pinch sensor installed to the flange.

The invention provides an easy install anti-pinch sensor for horizontal or vertical thermoplastic exterior body closures in accordance with aspects of the present invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of a liftgate having an anti-pinch sensor in accordance with the present invention;

FIG. 2 is a detailed sectional view of the anti-pinch sensor area of FIG. 1;

FIG. 3 is a perspective view of a closure panel assembly having an anti-pinch sensor adapted for a vehicle with the closure panel depicted as a hood in an open position, in accordance with the present invention;

FIG. 4 is a perspective view of the anti-pinch sensor area of FIG. 3 with the closure panel depicted as the hood in a closed position in accordance with the present invention;

FIG. 5 is a side elevation view of a closure panel having an anti-pinch sensor adapted for a vehicle with the closure panel depicted as a door that is hingable, in accordance with the present invention;

FIG. 6 is a side elevation of a closure panel having an anti-pinch sensor adapted for a vehicle with the closure panel depicted as a door that is slidable, in accordance with the present invention;

FIG. 7 is a perspective view of a closure panel having an anti-pinch sensor adapted for a vehicle with the closure panel depicted as a decklid, in accordance with the present invention;

FIG. 8 is a detailed sectional view of an anti-pinch sensor area of FIG. 4; and

FIG. 9 is a detailed sectional view of an anti-pinch sensor area of the closure panel of FIG. 6 with the closure panel in an exemplary closed position.

### DETAILED DESCRIPTION OF THE PREFERRED EMBODIMENTS

The following description of the preferred embodiment(s) is merely exemplary in nature and is in no way intended to limit the invention, its application, or uses.

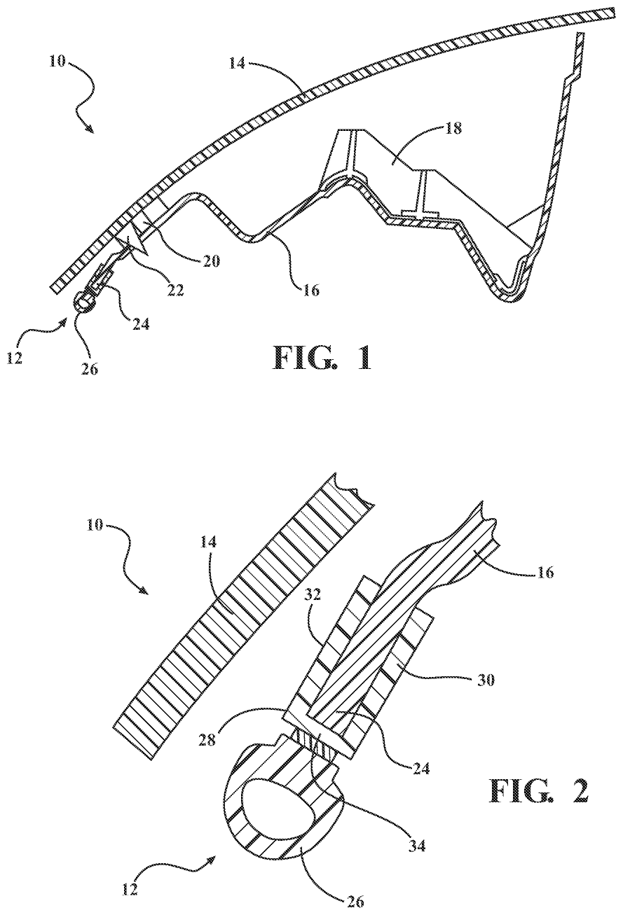

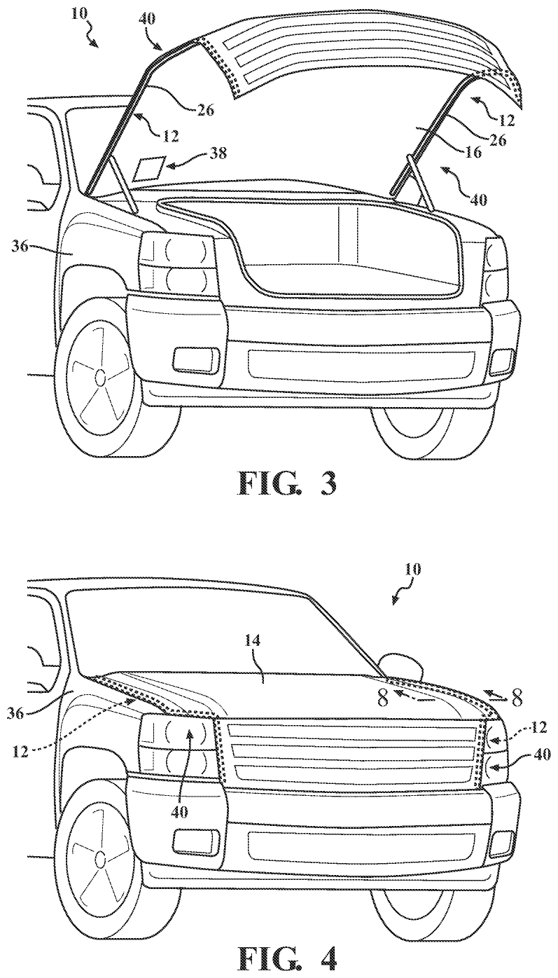

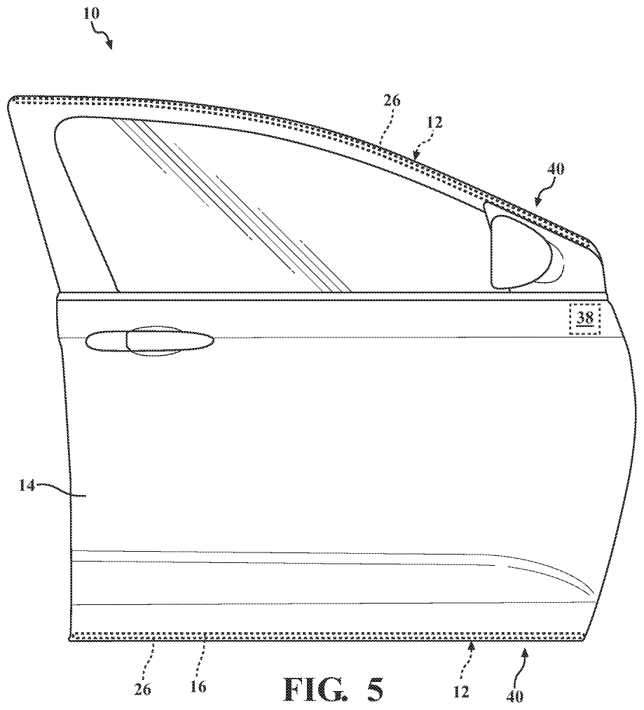

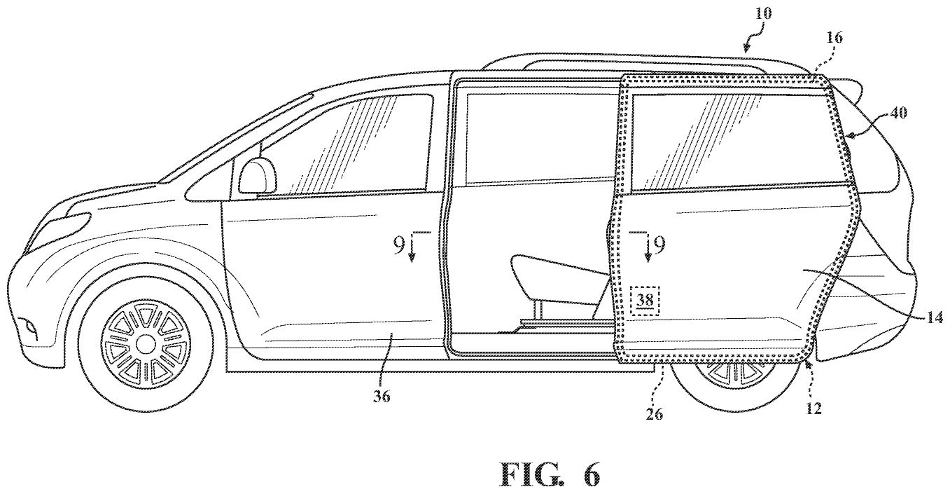

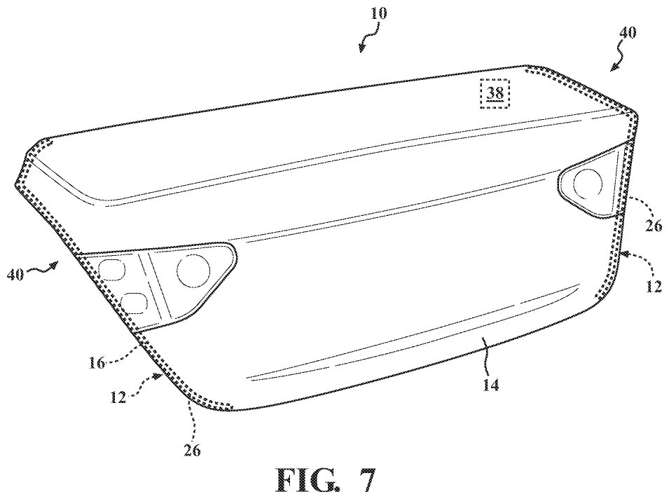

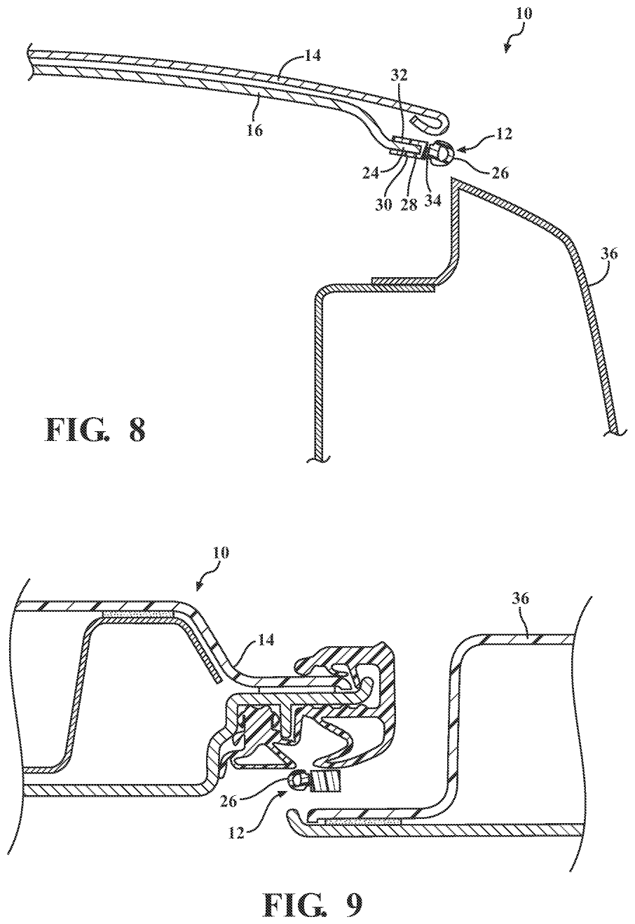

Referring to FIGS. 1-9 in general, in accordance with the present invention there is provided an anti-pinch sensor operably adapted for connecting to closure panels. The present invention provides at least one anti-pinch sensor operably adapted for connecting to a respective exterior body closure or “closure panel assembly”, e.g., liftgate, hood, frunk, forward storage compartment, frunk cover, forward storage cover, electric vehicle's front storage area or cover, door, sliding door, side door, hinged door, rear door, storage lid, tailgate, decklid, trunk, rear storage compartment, trunk cover, decklid cover, storage compartment cover, etc. or any other exterior body closure, operably adapted to connect to a vehicle. The invention provides an easy install anti-pinch sensor for body closures, e.g., horizontal or vertical thermoplastic exterior body closures, in accordance the present invention.

In accordance with the present invention there is provided a liftgate for a vehicle generally shown at 10. The liftgate 10 has an anti-pinch sensor generally shown at 12 attached at an outer peripheral area of the liftgate 10. The liftgate 10 includes an outer show surface panel 14 and an inner panel 16. The inner panel 16 includes reinforcement structure 18. Attachment structure 20, 22 attaches the inner panel 16 to outer panel 14. The inner panel 16 is preferably formed of a filled thermoplastic and includes an outwardly extending flange portion 24.

Anti-pinch sensor 12 includes an outer pinch sensor bulb portion 26 and a pinch sensor mount 28. The mount portion 28 including a U-shaped cross section formed by two outer legs 30 and 32 connected by an inner wall 34 this mount is designed to fit over and secure to the outwardly extending flange portion 24. Preferably the mount portion 28 is adapted for press fitting onto the flange 24. Preferably the anti-pinch sensor bulb 26 and the pinch sensor mount 28 are an elongated one-piece extrusion. Typically, the mount portion 28 is mechanically attached and is of a durometer that will provide enough compression to hold onto the flange 24. However, mount 28 can also be glued to the flange 24 with butyl adhesives or the like if further securement is necessary. Mechanical fasteners, staples and/or crimping of the flange are also used in other embodiments. Additionally, the flange 24 in other embodiments includes a stepped surface or openings which can promote securement of the mount portion 28 onto the flange.

The anti-pinch sensor bulb 26 is attached to the mount portion for sensing an interference in opening or closing of the liftgate and reversing the opening or closing of the liftgate thus the anti-pinch sensor bulb portion 26 is of a softer durometer than the mount to provide proper compression for sensing of an object which interferes with opening or closing of the liftgate.

The anti-pinch sensor 12 is operably adaptable for suitably connecting to at least one panel of any closure panels 10, e.g., liftgate, hood, frunk, forward storage compartment, frunk cover, forward storage cover, electric vehicle's front storage area or cover, door, sliding door, side door, hinged door, rear door, storage lid, tailgate, decklid, trunk, rear storage compartment, trunk cover, decklid cover, storage compartment cover, etc., operably adapted to connect to a vehicle.

Referring more particularly to FIGS. 1-4 and 8, in accordance with the present invention there is provided a closure panel assembly shown at 10 (e.g., a hood, frunk, front-end storage compartment) operably adapted for connecting to a vehicle 36. The closure panel 10 has an anti-pinch sensor 12 attached at an outer peripheral area of the closure panel 10. The closure panel 10 includes at least one panel, e.g., inner panel and/or outer panel) with at least one anti-pinch sensor 12 operably connected thereto. More particularly, the closure panel 10 preferably includes a first panel 14, e.g., an outer show surface panel, and a second panel 16, e.g., an inner panel 16. The inner panel 16 includes reinforcement structure 18 (e.g., see FIG. 1). Predetermined attachment structure 20, 22 are preferably provided to attach the second panel 16 to the outer panel 14 (e.g., see FIG. 1). The second panel 16 is preferably formed of a filled thermoplastic. The second panel 16 includes the outwardly extending flange portion 24 (e.g., see FIGS. 1-2 and 8). It is understood that, alternatively, the first panel 14 includes an operably extending flange portion 24.

The closure panel 10 includes at least one of the anti-pinch sensors 12 attached adjacent at least one outer peripheral area, indicated generally at 40, of the closure panel 10. According to aspects of the present invention, at least two of the anti-pinch sensors 12, 12 on at least two outer peripheral areas 40, 40, respectively.

The anti-pinch sensor 12 includes an outer pinch sensor bulb portion 26 and a pinch sensor mount 28 (e.g., see FIGS. 1-2, 4 and 8). The mount portion 28 including a U-shaped cross section formed by two outer legs 30 and 32 connected by an inner wall 34 this mount is designed to fit over and secure to the outwardly extending flange portion 24 (e.g., see FIGS. 1-2). Preferably the mount portion 28 is adapted for press fitting onto the flange 24. Preferably the anti-pinch sensor bulb 26 and the pinch sensor mount 28 are an elongated one-piece extrusion. Typically, the mount portion 28 is mechanically attached and is formed of at least one predetermined durometer that will provide enough compression to hold onto the flange 24. However, mount 28 can also be glued to the flange 24 with butyl adhesives or the like if further securement is necessary. Mechanical fasteners, staples and/or crimping of the flange are also contemplated according to aspects of the present invention. According to aspects of the present invention, the pinch sensor mount is additionally secured with adhesive, mechanical fasteners, or combinations of adhesive and mechanical fasteners. The flange 24 according to aspects of the present invention includes a stepped surface and/or openings which can promote operable securement of the mount portion 28 onto the flange 24.

The anti-pinch sensor bulb 26 is attached to the mount portion for sensing an interference in opening or closing of the closure panel 10. The closure panel 10 is operably adapted for reversing the opening or closing of the closure panel 10 (e.g., by an operably coupled predetermined device indicated at 38 in a predetermined location, actuator, motor, or other suitable device or mechanism operably adapted for automatically reversing opening/closing of the closure panel 10 a predetermined amount) if an interference is sensed. Thus, the anti-pinch sensor bulb portion 26 is of a predetermined softer durometer than the pinch sensor mount 28 to provide proper compression for sensing of an object which interferes with opening or closing of the closure panel 10.

The anti-pinch sensor 12 bulb 26 and pinch sensor mount 24 are preferably an integral extrusion. Either the first or second panel 14 or 16, e.g., inner panel 16, is preferably a molded panel having an integrally molded outer flange 24 for engagement of the mount portion of the anti-pinch sensor 12.

Referring more particularly to FIGS. 1-2 and 5, in accordance with the present invention there is provided a closure panel assembly shown at 10 (e.g., a door, side door, hingeable door, swingable door, etc.) operably adapted for connecting to a vehicle 36. The closure panel 10 has an anti-pinch sensor at 12 attached at an outer peripheral area of the closure panel 10. The closure panel 10 includes at least one panel, e.g., inner panel and/or outer panel) with at least one anti-pinch sensor 12 operably connected thereto. More particularly, the closure panel 10 preferably includes a first panel 14, e.g., an outer show surface panel, and a second panel 16, e.g., an inner panel 16. The inner panel 16 includes reinforcement structure 18 (e.g., see FIG. 1). Predetermined attachment structure 20, 22 are preferably provided to attach the second panel 16 to the outer panel 14 (e.g., see FIG. 1). The second panel 16 is preferably formed of a filled thermoplastic. The second panel 16 includes the outwardly extending flange portion 24 (e.g., see FIGS. 1-2). It is understood that, alternatively, the first panel 14 includes an operably extending flange portion 24.

The closure panel 10 includes at least one of the anti-pinch sensors 12 attached adjacent at least one outer peripheral area, indicated generally at 40, of the closure panel 10. According to aspects of the present invention, at least two of the anti-pinch sensors 12, 12 on at least two outer peripheral areas 40, 40, respectively.

The anti-pinch sensor 12 includes an outer pinch sensor bulb portion 26 and a pinch sensor mount 28 (e.g., see FIGS. 1-2 and 5). The mount portion 28 including a U-shaped cross section formed by two outer legs 30 and 32 connected by an inner wall 34 this mount is designed to fit over and secure to the outwardly extending flange portion 24 (e.g., see FIGS. 1-2). Preferably the mount portion 28 is adapted for press fitting onto the flange 24. Preferably the anti-pinch sensor bulb 26 and the pinch sensor mount 28 are an elongated one-piece extrusion. Typically, the mount portion 28 is mechanically attached and is formed of at least one predetermined durometer that will provide enough compression to hold onto the flange 24. However, mount 28 can also be glued to the flange 24 with butyl adhesives or the like if further securement is necessary. Mechanical fasteners, staples and/or crimping of the flange are also contemplated according to aspects of the present invention. According to aspects of the present invention, the pinch sensor mount is additionally secured with adhesive, mechanical fasteners, or combinations of adhesive and mechanical fasteners. The flange 24 according to aspects of the present invention includes a stepped surface and/or openings which can promote operable securement of the mount portion 28 onto the flange 24.

The anti-pinch sensor bulb 26 is attached to the mount portion for sensing an interference in opening or closing of the closure panel 10. The closure panel 10 is operably adapted for reversing the opening or closing of the closure panel 10 (e.g., by an operably coupled predetermined device indicated at 38 in a predetermined location, actuator, motor, or other suitable device or mechanism operably adapted for automatically reversing opening/closing of the closure panel 10 a predetermined amount) if an interference is sensed. Thus, the anti-pinch sensor bulb portion 26 is of a predetermined softer durometer than the pinch sensor mount 28 to provide proper compression for sensing of an object which interferes with opening or closing of the closure panel 10.

The anti-pinch sensor 12 bulb 26 and pinch sensor mount 24 are preferably an integral extrusion. Either the first or second panel 14 or 16, e.g., inner panel 16, is preferably a molded panel having an integrally molded outer flange 24 for engagement of the mount portion of the anti-pinch sensor 12.

Referring more particularly to FIGS. 1-2, 6 and 9, in accordance with the present invention there is provided a closure panel assembly 10 (e.g., a door, side door, slideable door, etc.) operably adapted for connecting to a vehicle 36. The closure panel 10 has an anti-pinch sensor 12 attached at an outer peripheral area of the closure panel 10. The closure panel 10 includes at least one panel, e.g., inner panel and/or outer panel) with at least one anti-pinch sensor 12 operably connected thereto. More particularly, the closure panel 10 preferably includes a first panel 14, e.g., an outer show surface panel, and a second panel 16, e.g., an inner panel 16. The inner panel 16 includes reinforcement structure 18 (e.g., see FIG. 1). Predetermined attachment structure 20, 22 are preferably provided to attach the second panel 16 to the outer panel 14 (e.g., see FIG. 1). The second panel 16 is preferably formed of a filled thermoplastic. The second panel 16 includes the outwardly extending flange portion 24 (e.g., see FIGS. 1-2). It is understood that, alternatively, the first panel 14 includes an operably extending flange portion 24.

The closure panel 10 includes at least one of the anti-pinch sensors 12 attached adjacent at least one outer peripheral area, indicated generally at 40, of the closure panel 10. According to aspects of the present invention, at least two of the anti-pinch sensors 12, 12 on at least two outer peripheral areas 40, 40, respectively. Preferably, the anti-pinch sensors 12 extends the entire outer peripheral area of the closure panel assembly 10.

The anti-pinch sensor 12 includes an outer pinch sensor bulb portion 26 and a pinch sensor mount 28 (e.g., see FIGS. 1-2 and 6). The mount portion 28 including a U-shaped cross section formed by two outer legs 30 and 32 connected by an inner wall 34 this mount is designed to fit over and secure to the outwardly extending flange portion 24 (e.g., see FIGS. 1-2). Preferably the mount portion 28 is adapted for press fitting onto the flange 24. Preferably the anti-pinch sensor bulb 26 and the pinch sensor mount 28 are an elongated one-piece extrusion. Typically, the mount portion 28 is mechanically attached and is formed of at least one predetermined durometer that will provide enough compression to hold onto the flange 24. However, mount 28 can also be glued to the flange 24 with butyl adhesives or the like if further securement is necessary. Mechanical fasteners, staples and/or crimping of the flange are also contemplated according to aspects of the present invention. According to aspects of the present invention, the pinch sensor mount is additionally secured with adhesive, mechanical fasteners, or combinations of adhesive and mechanical fasteners. The flange 24 according to aspects of the present invention includes a stepped surface and/or openings which can promote operable securement of the mount portion 28 onto the flange 24.

The anti-pinch sensor bulb 26 is attached to the mount portion for sensing an interference in opening or closing of the closure panel 10. The closure panel 10 is operably adapted for reversing the opening or closing of the closure panel 10 (e.g., by an operably coupled predetermined device indicated at 38 in a predetermined location, actuator, motor, or other suitable device or mechanism operably adapted for automatically reversing opening/closing of the closure panel 10 a predetermined amount) if an interference is sensed. Thus, the anti-pinch sensor bulb portion 26 is of a predetermined softer durometer than the pinch sensor mount 28 to provide proper compression for sensing of an object which interferes with opening or closing of the closure panel 10.

The anti-pinch sensor 12 bulb 26 and pinch sensor mount 24 are preferably an integral extrusion. Either the first or second panel 14 or 16, e.g., inner panel 16, is preferably a molded panel having an integrally molded outer flange 24 for engagement of the mount portion of the anti-pinch sensor 12.

Referring more particularly to FIGS. 1-2 and 7 in accordance with the present invention there is provided a closure panel assembly 10 (e.g., frunk, forward storage compartment, frunk cover, forward storage cover, etc.) operably adapted for connecting to a vehicle 36. The closure panel 10 has at least one anti-pinch sensor 12 attached at an outer peripheral area of the closure panel 10. The closure panel 10 includes at least one panel, e.g., inner panel and/or outer panel) with at least one anti-pinch sensor 12 operably connected thereto. More particularly, the closure panel 10 preferably includes a first panel 14, e.g., an outer show surface panel, and a second panel 16, e.g., an inner panel 16. The inner panel 16 includes reinforcement structure 18 (e.g., see FIG. 1). Predetermined attachment structure 20, 22 are preferably provided to attach the second panel 16 to the outer panel 14 (e.g., see FIG. 1). The second panel 16 is preferably formed of a filled thermoplastic. The second panel 16 includes the outwardly extending flange portion 24 (e.g., see FIGS. 1-2). It is understood that, alternatively, the first panel 14 includes an operably extending flange portion 24.

The closure panel 10 includes at least one of the anti-pinch sensors 12 attached adjacent at least one outer peripheral area, indicated generally at 40, of the closure panel 10. According to aspects of the present invention, at least two of the anti-pinch sensors 12, 12 on at least two outer peripheral areas 40, 40, respectively.

The anti-pinch sensor 12 includes an outer pinch sensor bulb portion 26 and a pinch sensor mount 28 (e.g., see FIGS. 1-2 and 7). The mount portion 28 including a U-shaped cross section formed by two outer legs 30 and 32 connected by an inner wall 34 this mount is designed to fit over and secure to the outwardly extending flange portion 24 (e.g., see FIGS. 1-2). Preferably the mount portion 28 is adapted for press fitting onto the flange 24. Preferably the anti-pinch sensor bulb 26 and the pinch sensor mount 28 are an elongated one-piece extrusion. Typically, the mount portion 28 is mechanically attached and is formed of at least one predetermined durometer that will provide enough compression to hold onto the flange 24. However, mount 28 can also be glued to the flange 24 with butyl adhesives or the like if further securement is necessary. Mechanical fasteners, staples and/or crimping of the flange are also contemplated according to aspects of the present invention. According to aspects of the present invention, the pinch sensor mount is additionally secured with adhesive, mechanical fasteners, or combinations of adhesive and mechanical fasteners. The flange 24 according to aspects of the present invention includes a stepped surface and/or openings which can promote operable securement of the mount portion 28 onto the flange 24.

The anti-pinch sensor bulb 26 is attached to the mount portion for sensing an interference in opening or closing of the closure panel 10. The closure panel 10 is operably adapted for reversing the opening or closing of the closure panel 10 (e.g., by an operably coupled predetermined device indicated at 38 in a predetermined location, actuator, motor, or other suitable device or mechanism operably adapted for automatically reversing opening/closing of the closure panel 10 a predetermined amount) if an interference is sensed. Thus, the anti-pinch sensor bulb portion 26 is of a predetermined softer durometer than the pinch sensor mount 28 to provide proper compression for sensing of an object which interferes with opening or closing of the closure panel 10.

The anti-pinch sensor 12 bulb 26 and pinch sensor mount 24 are preferably an integral extrusion. Either the first or second panel 14 or 16, e.g., inner panel 16, is preferably a molded panel having an integrally molded outer flange 24 for engagement of the mount portion of the anti-pinch sensor 12.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A closure panel assembly operably adapted for a vehicle, comprising:
at least one anti-pinch sensor attached to at least one predetermined outer peripheral area of at least one panel;
at least one outwardly extending flange portion provided on said at least one panel;
at least one anti-pinch sensor mount including a U-shaped cross section which is adapted to fit over and secure to the outwardly extending flange portion; and,
wherein said anti-pinch sensor is operably attached to the anti-pinch sensor mount for sensing an interference in opening or closing of the closure panel assembly and operably reversing the opening or closing of the closure panel assembly.

2. The closure panel assembly operably adapted for a vehicle of claim 1, wherein the anti-pinch sensor mount includes a U-shaped member which is pushed onto an outer peripheral flange and is secured on the flange.

3. The closure panel assembly operably adapted for a vehicle of claim 2, wherein the closure panel assembly includes an outer show surface panel and an inner panel, wherein the inner panel includes said outer peripheral flange.

4. The closure panel assembly operably adapted for a vehicle of claim 1, wherein the anti-pinch sensor and the pinch sensor mount are an integral extrusion.

5. The closure panel assembly operably adapted for a vehicle of claim 1, wherein the pinch sensor mount is of a predetermined durometer which allows the pinch sensor mount to hold onto the flange and a bulb of the anti-pinch sensor is of a predetermined durometer which allows the anti-pinch sensor to compress with respect to an object interfering with the opening or closing of the closure panel assembly.

6. The closure panel assembly operably adapted for a vehicle of claim 1, wherein the pinch sensor mount is additionally secured with adhesive, mechanical fasteners, or combinations of adhesive and mechanical fasteners.

7. The closure panel assembly operably adapted for a vehicle of claim 3, wherein the inner panel is a molded panel having an integrally molded outer flange for engagement of the mount portion of the anti-pinch sensor.

8. The closure panel assembly for a vehicle of claim 1, wherein the closure panel assembly is a liftgate.

9. The closure panel assembly for a vehicle of claim 1, wherein the closure panel assembly is a hood.

10. The closure panel assembly for a vehicle of claim 1, wherein the closure panel assembly is a frunk or forward storage compartment.

11. The closure panel assembly for a vehicle of claim 1, wherein the closure panel assembly is a side door or slideable side door.

12. The closure panel assembly for a vehicle of claim 1, wherein the closure panel assembly is a trunk cover or decklid.

13. A closure panel assembly for a vehicle operably adapted for an anti-pinch sensor attached at an outer peripheral area of the closure panel assembly, comprising:
a closure including an outer show surface panel and an inner panel, wherein the inner panel includes at least one outwardly extending peripheral flange portion,
at least one anti-pinch sensor mount including a U-shaped cross section which is adapted to fit over and secure to the outwardly extending peripheral flange portion; and,
at least one anti-pinch sensor attached to the anti-pinch sensor mount operably adapted for sensing an interference in opening or closing of the closure panel assembly and operably reversing the opening or closing of the closure panel assembly.

14. The closure panel assembly for a vehicle of claim 13, wherein the anti-pinch sensor mount includes a U-shaped member which is pushed onto the outwardly extending peripheral flange portion and is secured on said flange.

15. The closure panel assembly for a vehicle of claim 13, wherein the anti-pinch sensor and the pinch sensor mount are an integral extrusion.

16. The closure panel assembly for a vehicle of claim 13, wherein the anti-pinch mount is of a predetermined durometer which allows the mount to hold onto the flange and the bulb is of a predetermined durometer which allows the anti-pinch sensor to compress with respect to an object interfering with the opening or closing of the closure panel assembly.

17. The closure panel assembly having an anti-pinch sensor of claim 13, wherein the outwardly extending flange portion is provided over pre-selected areas for the outwardly extending flange portion.

18. The closure panel assembly for a vehicle of claim 13, wherein the inner panel is a molded panel having an integrally molded outer flange for engagement of the anti-pinch sensor mount portion of the anti-pinch sensor.

19. The closure panel assembly having an anti-pinch sensor of claim 13, wherein the outwardly extending flange portion is provided over the entire outer peripheral area of the closure panel assembly.

20. An exterior body closure operably adapted for a vehicle, comprising:
at least one panel;
at least one anti-pinch sensor attached to at least one predetermined outer peripheral area of said at least one panel;
at least one outwardly extending flange portion provided on said at least one panel;
at least one anti-pinch sensor mount including a U-shaped cross section which is adapted to fit over and secure to the outwardly extending flange portion; and,
wherein said anti-pinch sensor is operably attached to the anti-pinch sensor mount operably adapted for sensing an interference in opening or closing of the of said at least one panel.
